(19) United States
(12) Patent Application Publication
(10) Pub. No.: US 2014/0172779 A1
(43) Pub. Date: Jun. 19, 2014

(54) MAINTAINING AND UTILIZING A REPORT KNOWLEDGEBASE

(71) Applicants: Ray Tanushree, Bangalore Karnataka (IN); Ramananda Balasubramanya, Bangalore Karnataka (IN)

(72) Inventors: Ray Tanushree, Bangalore Karnataka (IN); Ramananda Balasubramanya, Bangalore Karnataka (IN)

(21) Appl. No.: 14/235,134

(22) PCT Filed: Jul. 27, 2011
(86) PCT No.: PCT/US2011/045597

§ 371 Date: Jan. 27, 2014

(51) Int. Cl. G06F 17/30

(52) U.S. Cl. CPC G06F 17/30011
USPC 707/603

(57) ABSTRACT

A method includes recording a report navigation workflow followed by any of a plurality of users. The recorded report navigation workflow included data identifying an ordered series of reports selected from a plurality of reports. The report navigation workflow is electronically saved. The acts of recording and saving are repeated to maintain a report knowledgebase. The report knowledgebase is utilized to guide a subsequent report navigation for one of the plurality of users.

### BACKGROUND

Computer generated reports are used in many industries to make decisions. In the IT industry, for example, such reports may supply information concerning the performance and availability of infrastructure elements. Different individuals can use these reports to arrive at decisions such as long-term capacity planning, hardware refresh, and improving performance to meet service level agreements. Often, a user navigates through a series of reports to obtain information sufficient for making an informed decision. This navigation among the reports defines a workflow. Over time, different users may benefit from being able to repurpose the workflow of another or otherwise utilize data related to another user's use of the various reports.

### DRAWINGS

FIG. 1 depicts an environment in which various embodiments may be implemented.

FIG. 2 depicts a system according to an embodiment.

FIG. 3 depicts a visual representation of a report navigation workflow according to an embodiment.

FIG. 4 depicts the logical elements of a report knowledgebase according to an embodiment.

FIG. 5 is a block diagram depicting a memory and a processor according to an embodiment.

FIG. 6 is a block diagram depicting an implementation of the system of FIG. 2.

FIG. 7 is a flow diagram depicting steps taken to implement an embodiment.

### DETAILED DESCRIPTION

Introduction:

Various embodiments described below were developed in an effort to maintain and utilize a report knowledgebase to guide a user navigating a series of computer generated reports. The report knowledgebase is maintained using report navigation data recorded as users navigate through the reports. The recorded data can be used to define report navigation workflows as well as dimension data. A workflow can identify an ordered series of reports as well as parameters passed for generating each of those reports. Dimension data can be recorded for each instance or use of a report by a given user. In other words, an instance of a report occurs when a user causes the report to be generated. Dimension data can include, for each instance, data identifying the user's role, the user organization, the user's location, and a usage date or timestamp. As the knowledge base grows, it can be utilized to guide the report navigation of the users. Such guidance can include recommending a next report to which a user may navigate as well as the selection and execution of a recorded workflow.

The following description is broken into sections. The first, labeled “Environment,” describes an exemplary environment in which various embodiments may be implemented. The second section, labeled “Components,” describes examples of various physical and logical components for implementing various embodiments. The third section, labeled as “Operation,” describes steps taken to implement various embodiments.

Environment:

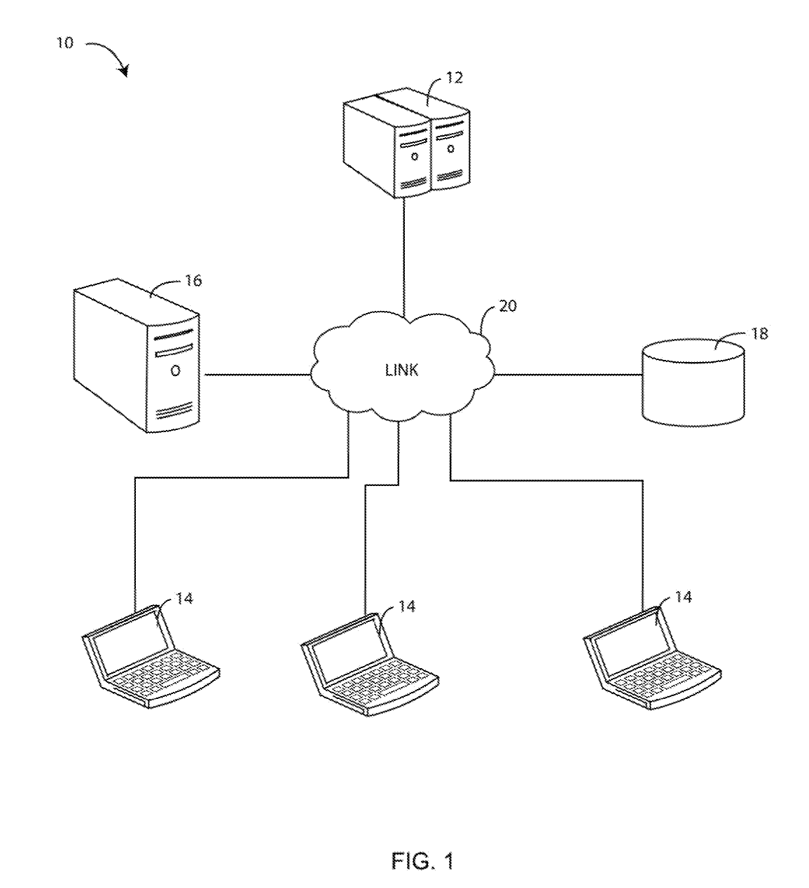

FIG. 1 depicts an environment 10 in which various embodiments may be implemented. Environment 10 is shown to include application device 12, client devices 14, knowledgebase device 16, and data store 18. Application device 12 represents generally any computing device or collection of computing devices configured to generate and communicate reports to client devices. As used herein, a report is electronic data that can be presented to a user. Presentation can take a number of forms including presenting as part of a graphical user interface and printing. Presentation may also include providing the electronic data in a format that can be later displayed or printed. A report is used to communicate information concerning a topic of interest. For example, in an IT environment a report may communicate information regarding the performance of a server or the utilization of a virtual machine.

Client devices 14 each represent a computing device capable of being used to request reports from application device 12. The requesting of a report, for example, can include passing parameters to application device 12 that can be used to generate the requested report. Knowledgebase device 16 represents a computing device or combination of computing devices configured to maintain a knowledgebase in data store 18 using report navigation data recorded for users of client devices 14. Report navigation data is data gleaned as the users request reports. In particular, the report navigation data is data that can be used to define dimensions for each instance of a report and to define report navigation workflows. Thus the knowledgebase includes either or both of the dimension data and the report navigation workflows and is used by knowledgebase device 16 to guide a subsequent report navigation for a user. Data store 18 represents generally any device or combination of devices capable of storing electronic data that can be updated and utilized by knowledgebase device in the performance of its functions.

In the example of FIG. 1, application device 12, knowledgebase device 16, and data store 18 are depicted as distinct devices. However, devices 12, 16, and 18 may be wholly or partially integrated with one another. For example application device 12 and knowledgebase device 16 may be integrated in a single device or distributed together across multiple devices. Likewise, data store 18 may be integrated wholly or partially with knowledgebase device 16 or application device 12.

Link 20 represents generally one or more of a cable, wireless, fiber optic, or remote connections via a telecommunication link, an infrared link, a radio frequency link, or any other connectors or systems that provide electronic communication. Link 20 may include, at least in part, an intranet, the Internet, or a combination of both. Link 20 may also include intermediate proxies, routers, switches, load balancers, and the like.

Components:

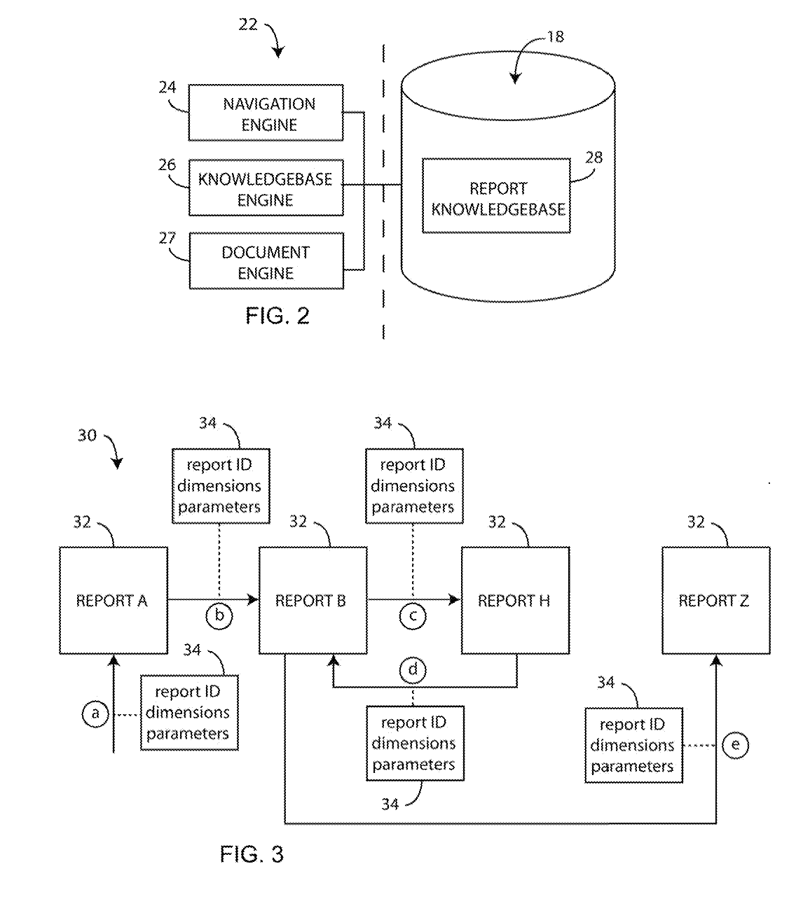

FIGS. 2-6 depict examples of physical and logical components for implementing various embodiments. FIG. 2 depicts system 22 for maintaining and utilizing a report knowledgebase. In this example, system 22 is shown to include navigation engine 24, knowledgebase engine 26, and document engine 27. FIG. 2 also depicts data store 18 containing report knowledgebase 28.

Navigation engine 24 represents generally any combination of hardware and programming configured to record report navigation data for a plurality of users. Report navigation data is electronic data corresponding to the users' interactions with various reports. In particular report navigation data can include dimension data for report instances, parameters passed to generate reports, and report sequences followed by users. Thus, the report navigation data can be used to define either or both of report navigation workflows followed by a plurality of users and dimension data for each instance of each report generated by the plurality of users.

In performing its function, navigation engine 24, for example, may intercept communication between a client and an application responsible for generating and returning the reports to glean the report navigation data. Navigation engine 24 may receive the report navigation data directly from that application or from a third party. For example, the application may actively communicate the report navigation data to navigation engine 24 or it may record the report navigation data locally or in a third party repository such that it may be accessed by navigation engine 24.

Knowledgebase engine 26 represents generally any combination of hardware and programming configured to maintain report knowledgebase 28 using the recorded report navigation data. Knowledgebase engine 26 is also responsible for utilizing the report knowledgebase to guide a subsequent report navigation for one of the plurality of users. In guiding the subsequent report navigation, knowledgebase engine 26 may recommend a next report to which a user might navigate. In doing so, knowledgebase engine 26 may cause a control to be displayed on the user interface of a client that identifies the next report and perhaps provides a link for accessing that next report. Such may be accomplished by intercepting and modifying a current report being prior to it being delivered from an application to the client. Such may also include providing the application with the data needed to generate the report so it includes the recommendation.

Knowledgebase engine 26 may maintain report knowledgebase 28 such that it includes either or both of report navigation work flows and dimension data. Note that each report navigation workflow can include data identifying a series of reports navigated by a user as well as parameters passed to generate each of those reports. The dimension data tied to each report instance may identify any of a user identity that requested the report, the user's role or persona, the user's organization, the user's location, and a timestamp.

Knowledgebase engine 26 may then utilize report knowledgebase 28 by utilizing either or both of the dimension data and the report navigation workflows to recommend a next report to which a user may navigate. For example, a user may be viewing one report that provides access to a number of other reports. Examining the dimension data, knowledgebase engine 26 can identify which of the other reports may be relevant to the user and then recommend one or more of those reports. Again the recommendation may be made by causing a user interface that displays a current report to include a control or other image that communicates the recommendation to the user.

Examining the report navigation workflows, knowledgebase engine 26 can identify a report that other user's commonly navigate to from a current report being viewed. For example, engine 26 may identify report navigation workflows that identify the current report and then identify a subsequent report that is more commonly navigated to from that current report. To further refine the recommendation, knowledgebase engine 26 may examine both the dimension data and the report navigation workflows to identify a subsequent report that is more relevant to the user presently viewing the current report. Rather than looking simply at the report navigation workflows, the dimension data can be used to identify a next report that is more commonly navigated to by similar users during a recent time period—that is—a report navigated to by user having, for example the same role or working in the same organization.

Knowledgebase engine 26 may also utilize report knowledgebase 28 to guide a subsequent navigation by executing a report navigation workflow selected from report knowledgebase 28. As noted, a report navigation workflow can identify a series of reports as well as parameters passed to generate each report in that series. Executing the workflow can include stepping the user through the series of reports. It can also include using some or all of the parameters from the report navigation workflow when generating each corresponding report in the workflow. Stepping the user the through the workflow, for example, can include from a current report being presented to the user, recommending or guiding the user to request or otherwise access the subsequent report identified in that report navigation workflow.

In maintaining report knowledgebase 28, knowledgebase engine 26 may associate each report navigation workflow with a tag corresponding to a problem or a solution identified by a user that navigated the reports identified by the workflow. The problem may be a problem the user was attempting to alleviate when navigating the reports. The solution may be a solution the user sought to achieve. In selecting a report navigation workflow from report knowledgebase, knowledgebase engine 26 may examine the tags to identify the particular report navigation workflow to be selected. That is, a current user may identify a problem, solution, or other data related to the tags allowing knowledgebase engine 26 to examine the tags in report knowledgebase 28 to identify a relevant report navigation workflow based on the user supplied data. Alternatively, the problem or desired solution may be determined automatically to cause knowledgebase engine 26 to select a relevant report navigation workflow.

Document engine 27 represents generally any combination of hardware and software configured to generate consolidated documents for report navigation workflows followed by the users. Each such document includes data identifying a sequence of reports of a given report navigation workflow and data identifying parameters passed to generate each report in the report navigation workflow. The consolidated document is an electronic document that can be stored and shared with others. Such consolidated document may be stored with corresponding tags as part of report knowledgebase 28. Thus in guiding a subsequent navigation, knowledgebase engine 26 may present a user with a consolidated document for a selected report navigation workflow.

FIG. 3 depicts a visual example of a report navigation workflow 30. In the example of FIG. 3, workflow 30 identifies a series of reports 32 as well as parameters and other data 34 corresponding to each report. Workflow 30 starts at (a) with parameters passed to generate report A. The instance of report A is tied to dimension data. The workflow passes through (b), (c), (d), and concludes with (e) and report Z. It is noted that workflow includes two instances of report B. A consolidated document discussed above may include information such as that shown in FIG. 3.

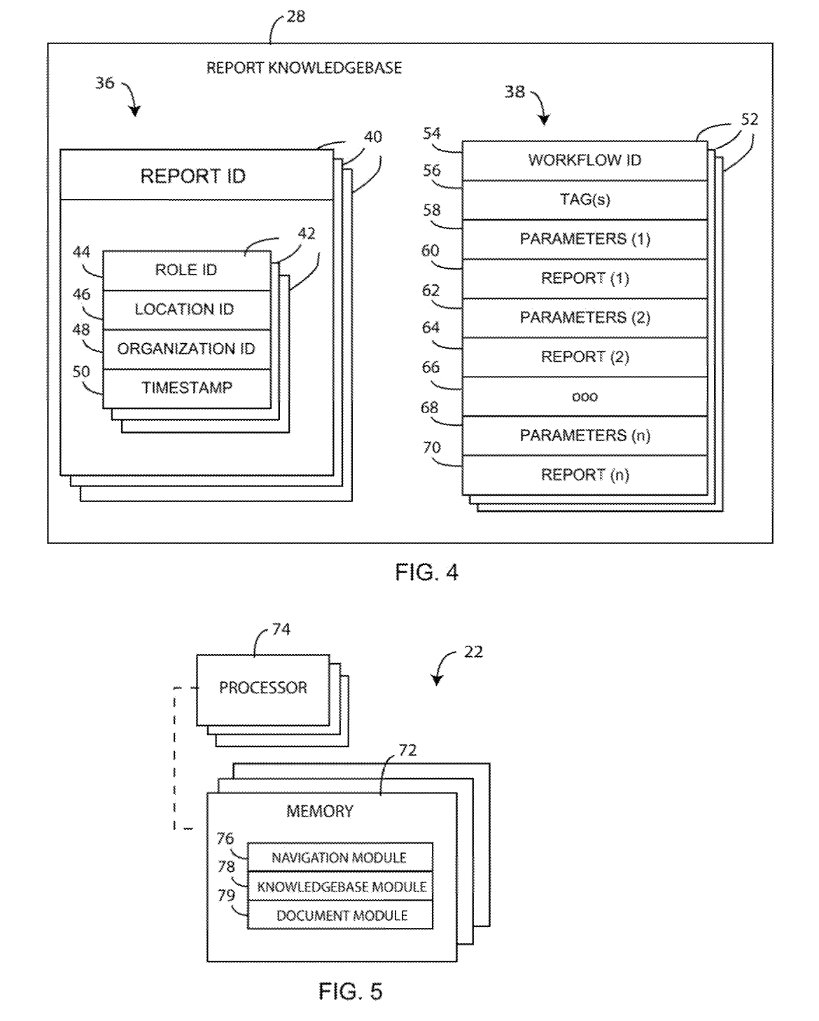

Moving to FIG. 4, a block diagram of the logical components of report knowledgebase 28 is depicted. In the example of FIG. 4, report knowledgebase 28 includes report data 36 and workflow data 38. Report data 36 includes a record 40 for each report of a plurality of reports that a user might utilize. Each report record includes dimension data 42 for each instance of that report over a period of time. In this example, dimension data includes data identifying the role 44 of the user the requested the given report instance, the user's location 46, the user's organization 48, and a timestamp 50 corresponding to that instance.

Workflow data 38 includes report navigation workflows 52. Each report navigation workflow 52 in this example includes a workflow identifier and tags 56. The workflow identifier 54 distinguishes a given report navigation workflow from others. The tags, as discussed above, may correspond to a problem or a solution for which report navigation workflow 52 was followed. Each workflow 52 also includes data 60, 64, and 68 that identifies parameters passed to generate reports identified by report identifiers 62, 66, and 70. Thus, each workflow 52 includes the data used by document engine 27 to generate a consolidated document as discussed above. Further, report data 36 and workflow data 38 contain the information used by workflow engine 26 to guide a report navigation for a user as explained above.

In foregoing discussion, various components were described as combinations of hardware and programming. Such components may be implemented in a number of fashions. Looking at FIG. 5, the programming may be processor executable instructions stored on tangible memory media 72 and the hardware may include a processor or processors 74 for executing those instructions. Memory 72 can be said to store program instructions that when executed by processor 74 implement system 22 of FIG. 2. Memory 72 may be integrated in the same device as processor 74 or it may be separate but accessible to that device and processor 74.

In one example, the program instructions can be part of an installation package that when installed can be executed by processor 74 to implement system 22. In this case, memory 72 may be a portable medium such as a CD, DVD, or flash drive or a memory maintained by a server from which the installation package can be downloaded and installed. In another example, the program instructions may be part of an application or applications already installed. Here, memory 72 can include integrated memory such as a hard drive.

In FIG. 5, the executable program instructions stored in memory 72 are depicted as navigation module 76, knowledgebase module 78, and document module 79. Navigation module 50 represents program instructions that when executed cause the implementation of navigation engine 24 of FIG. 2. Likewise, knowledgebase module 78 and document module 79 represent program instructions that when executed cause the implementation of knowledgebase engine 26 and document engine 27 respectively.

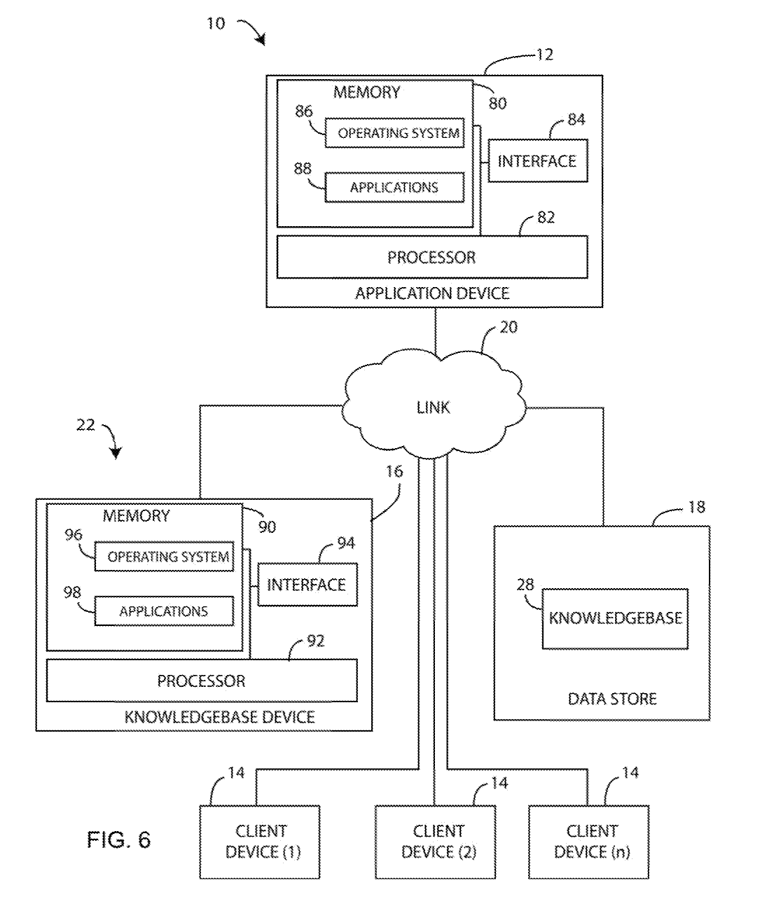

As a further example, FIG. 6 depicts a block diagram of system 22 implemented by knowledgebase device 16. In the example of FIG. 6, application device 12 is shown to include memory 80, processor 82, and interface 84. Processor 82 represents generally any processor configured to execute program instructions stored in memory 80 to perform various specified functions. Interface 58 represents generally any interface enabling application device 12 to communicate with client devices 14 and knowledgebase device 16 via link 20.

Memory 80 is shown to include operating system 86 and applications 88. Operating system 86 represents a collection of programs that when executed by processor 82 serve as a platform on which applications 88 can run. Examples of operating systems include, but are not limited, to various versions of Microsoft's Windows® and Linux®. Applications 88 represent program instructions that when execute by processor 82 function as an application that returns requested reports to client devices 14.

Knowledgebase device 16 is shown to include memory 90, processor 92, and interface 94. Processor 92 represents generally any processor configured to execute program instructions stored in memory 90 to perform various specified functions. Interface 94 represents generally any interface enabling knowledgebase device 16 to communicate via link 20.

Memory 90 is shown to include operating system 96 and applications 98. Operating system 96 represents a collection of programs that when executed by processor 92 serve as a platform on which applications 98 can run. Examples of operating systems include, but are not limited, to various versions of Microsoft's Windows® and Linux®. Applications 98 represent program instructions that when execute by processor 92 implement system 22 for maintaining and utilizing a report knowledgebase as discussed above with respect to FIG. 2.

Looking at FIG. 2, navigation 24, knowledgebase engine 26, and document engine 27 are described a combinations of hardware and programming. The hardware portions may, depending on the embodiment, be implemented as processor 92. The programming portions, depending on the embodiment, can be implemented by operating system 96, applications 98, or combinations thereof. It is also noted that while knowledgebase device 16 and application device 12 are illustrated as distinct devices, they may be wholly or partially integrated with one another. Further, while each device 12 and 16 is shown as an individual device, the functions and components of each may be distributed across multiple devices.

Operation:

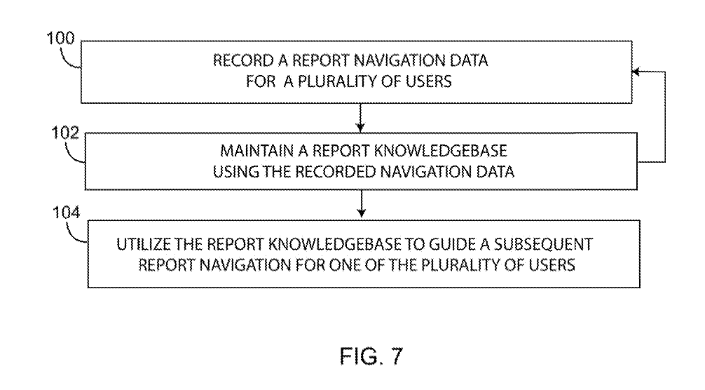

FIG. 7 is a flow diagram of steps taken to implement embodiment of a method for mainlining and utilizing a report knowledgebase. In discussing FIG. 7, reference is made to the diagrams of FIGS. 1-6 to provide contextual examples. Implementation, however, is not limited to those examples.

Report navigation data is recorded for a plurality of users (step 100). The report navigation data being useable to defining either or both of (a) report navigation workflows followed by the plurality of users and (b) dimension data for each instance of each report generated by the plurality of users. Referring to FIG. 2, navigation engine 24 may be responsible for implementing step 100. Step 100 may involve intercepting communications between a clients and an application responsible for returning requested reports in order to lean the report navigation data. Step 100 may include receiving the report navigation data from that application or a third party.

A report knowledgebase is maintained using the recorded report navigation data (step 102). In the example of FIG. 4, step 102 can include maintaining a knowledgebase 28 that includes either or both of dimension data 36 and workflow data 40. The report knowledgebase is utilized to guide subsequent report navigation for one of the plurality of users (step 104). Referring to FIG. 2, knowledgebase engine 26 may be responsible for implementing steps 102 and 104.

Step 104 may include utilizing the report knowledgebase to guide the one of the plurality of users through a subsequent report navigation by recommending to that user a next report to which the user may navigate. Such may be accomplished, for example, by causing a current report being presented to the user to include information indicative of that recommendation.

Step 102 may include maintaining a report knowledgebase that includes either or both of (a) report navigation workflows that each include data identifying an ordered series of reports navigated by a user and (b) dimension data that, for each instance of a report, identifies one of a user role, a user organization, a user location, and a time stamp. Step 104, then, can include utilizing either or both the report navigation workflows and the dimension data to recommend to the one of the plurality of users a next report to which the user may navigate.

Step 102 can include maintaining a report knowledgebase that includes navigation workflows that each include data identifying an ordered series of reports selected from a plurality of reports. Step 104, then, can include executing a selected report navigation workflow from the report knowledgebase. Where the selected report navigation workflow includes data identifying parameters passed to generate each report in that report navigation workflow, step 104 can include analyzing the data identifying the parameters and executing the report navigation workflow using one or more of those parameters.

Step 102 can include associating each report navigation workflow with a tag identifying one of a problem and a resolution. Step 104, then, can include examining the associated tags and selecting the report navigation workflow to be executed from the knowledge based on the examination of the associated tags.

Step 102 can include maintaining a report knowledgebase that includes a report navigation workflow followed by the one of the plurality of users being guided in step 104. In a step not depicted in FIG. 7, a consolidated document for that report navigation workflow can then be generated. The consolidated document includes data identifying a sequence of reports of the report navigation workflow and data identifying parameters passed to generate each report in the report navigation workflow. Step 102 then can include maintaining a report knowledgebase that includes such consolidated documents and guiding in step 104 can include causing a consolidated document for a selected report navigation workflow to be made available to the user.

Conclusion:

FIGS. 1-6 aid in depicting the architecture, functionality, and operation of various embodiments. In particular, FIGS. 1-6 depict various physical and logical components. Various components are defined at least in part as programs or programming. Each such component, portion thereof, or various combinations thereof may represent in whole or in part a module, segment, or portion of code that comprises one or more executable instructions to implement any specified logical function(s). Each component or various combinations thereof may represent a circuit or a number of interconnected circuits to implement the specified logical function(s).

Embodiments can be realized in any computer-readable media for use by or in connection with an instruction execution system such as a computer/processor based system or an ASIC (Application Specific Integrated Circuit) or other system that can fetch or obtain the logic from computer-readable media and execute the instructions contained therein. “Computer-readable media” can be any media that can contain, store, or maintain programs and data for use by or in connection with the instruction execution system. Computer readable media can comprise any one of many physical media such as, for example, electronic, magnetic, optical, electromagnetic, or semiconductor media. More specific examples of suitable computer-readable media include, but are not limited to, a portable magnetic computer diskette such as floppy diskettes or hard drives, a random access memory (RAM), a read-only memory (ROM), an erasable programmable read-only memory, or a portable compact disc.

Although the flow diagram of FIG. 7 shows a specific order of execution, the order of execution may differ from that which is depicted. For example, the order of execution of two or more blocks may be scrambled relative to the order shown. Also, two or more blocks shown in succession may be executed concurrently or with partial concurrence. All such variations are within the scope of the present invention.

The present invention has been shown and described with reference to the foregoing exemplary embodiments. It is to be understood, however, that other forms, details and embodiments may be made without departing from the spirit and scope of the invention that is defined in the following claims.

What is claimed is:

1. A processor implemented method, comprising:
recording report navigation data for a plurality of users, the report navigation data being useable to defining either or both of:
report navigation workflows followed by the plurality of users; and
dimension data for each instance of each report generated by the plurality of users;
maintaining a report knowledgebase using the recorded report navigation data; and
utilizing the report knowledgebase to guide subsequent report navigation for one of the plurality of users.

2. The method of claim 1, wherein utilizing comprises utilizing the report knowledgebase to guide the one of the plurality of users through a subsequent report navigation by recommending to that user a next report to which the user may navigate.

3. The method of claim 2, wherein;
maintaining comprises maintaining a report knowledgebase that includes either or both of:
report navigation workflows that each include data identifying an ordered series of reports navigated by a user; and
dimension data that, for each instance of a report, identifies one of a user role, a user organization, a user location, and a timestamp; and
utilizing comprises utilizing either or both the report navigation workflows and the dimension data to recommend to the one of the plurality of users a next report to which the user may navigate.

4. The method of claim 1, wherein:
maintaining comprises maintaining a report knowledgebase that includes navigation workflows that each include data identifying an ordered series of reports selected from a plurality of reports; and
utilizing the report knowledgebase to guide subsequent report navigation comprises executing a selected report navigation workflow from the report knowledgebase.

5. The method of claim 4, wherein:
the selected report navigation workflow includes data identifying parameters passed to generate each report in that report navigation workflow; and
executing comprises analyzing the data identifying the parameters for the selected report navigation workflow and executing the report navigation workflow using one or more of those parameters.

6. The method of claim 4, wherein:
maintaining includes associating each report navigation workflow with a tag identifying one of a problem and a resolution; and
utilizing the report knowledgebase to guide subsequent report navigation includes examining the associated tags and selecting the report navigation workflow to be executed from the knowledge based on the examination of the associated tags.

7. The method of claim 1, wherein maintaining includes maintaining a report knowledgebase that includes a report navigation workflow followed by the one of the plurality of users, and the method comprises generating a consolidated document for that report navigation workflow followed by the one of the plurality of users, the document including data identifying a sequence of reports of the report navigation workflow and data identifying parameters passed to generate each report in the report navigation workflow.

8. A system comprising a navigation engine and a report knowledgebase engine, wherein:
the navigation engine is configured to record report navigation data for a plurality of users, the report navigation data being useable to defining either or both of:
report navigation workflows followed by the plurality of users; and
dimension data for each instance of each report generated by the plurality of users;
the report knowledgebase engine is configured to maintain a report knowledgebase with the recorded report navigation data and utilize the report knowledgebase to guide a subsequent report navigation for one of the plurality of users.

9. The system of claim 8, wherein the report knowledgebase engine is configured to utilize the report knowledgebase to guide the one of the plurality of users through a subsequent report navigation by recommending to that user a next report to which the user may navigate.

10. The system of claim 9, wherein the report knowledgebase engine is configured to:
maintain a report knowledgebase that includes either or both of:
report navigation workflows that each include data identifying an ordered series of reports navigated by a user; and
dimension data that, for each instance of a report, identifies one of a user role, a user organization, a user location, and a timestamp; and
utilize either or both of the recorded navigation workflows and the dimension data to recommend to the one of the plurality of users a next report to which the user may navigate.

11. The system of claim 8, wherein the report knowledgebase engine is configured to:
maintain a report knowledgebase that includes navigation workflows that each include data identifying an ordered series of reports selected from a plurality of reports; and
guide a subsequent report navigation by executing a selected report navigation workflow selected from the report knowledgebase.

12. The system of claim 11, wherein:
each report navigation workflow includes data identifying parameters passed to generate each report in that report navigation workflow; and
the report knowledgebase engine is configured to analyze the data identifying the parameters for the selected report navigation workflow and to execute the report navigation workflow using one or more of those parameters.

13. The system of claim 11, wherein the report knowledgebase engine is configured to:
associate each report navigation workflow maintained in the report knowledgebase with a tag identifying one of a problem and a resolution; and
examine the associated tags and select the report navigation workflow to be executed from the knowledge based on the examination of the associated tags.

14. The system of claim 8, further comprising a document engine and wherein:
the report knowledgebase engine is configured to maintain a report knowledgebase that includes a report navigation workflow followed by the one of the plurality of users; and
the document engine is configured to generate a consolidated document for that report navigation workflow followed by the one of the plurality of users, the document including data identifying a sequence of reports of the report navigation workflow and data identifying parameters passed to generate each report in the report navigation workflow.

15. A computer readable medium having instructions stored thereon that when executed implement a system comprising:
a navigation engine to record report navigation data for a plurality of users, the report navigation data being useable to defining either or both of:
report navigation workflows followed by the plurality of users; and
dimension data for each instance of each report generated by the plurality of users; and
a report knowledgebase engine to maintain a report knowledgebase utilizing the recorded report navigation data and utilize the report knowledgebase to guide a subsequent report navigation for one of the plurality of users.

16. The medium of claim 15, wherein the report knowledgebase engine is configured to utilize the report knowledgebase to guide the one of the plurality of users through a subsequent report navigation by recommending to that user a next report to which the user may navigate.

17. The medium of claim 16, wherein the report knowledgebase engine is configured to:
maintain a report knowledgebase that includes either or both of:
report navigation workflows that each include data identifying an ordered series of reports navigated by a user; and
dimension data that, for each instance of a report, identifies one of a user role, a user organization, a user location, and a timestamp; and
utilize either or both of the recorded navigation workflows and the dimension data to recommend to the one of the plurality of users a next report to which the user may navigate.

18. The medium of claim 15, wherein the report knowledgebase engine is configured to:
maintain a report knowledgebase that includes navigation workflows that each include data identifying an ordered series of reports selected from a plurality of reports; and
guide a subsequent report navigation by executing a selected report navigation workflow selected from the report knowledgebase.

19. The medium of claim 18, wherein:
each report navigation workflow includes data identifying parameters passed to generate each report in that report navigation workflow; and
the report knowledgebase engine is configured to analyze the data identifying the parameters for the selected report navigation workflow and to execute the report navigation workflow using one or more of those parameters.

20. The medium of claim 18, wherein the system includes a document engine and wherein:
the report knowledgebase engine is configured to maintain a report knowledgebase that includes a report navigation workflow followed by the one of the plurality of users; and
the document engine is configured to generate a consolidated document for that report navigation workflow followed by the one of the plurality of users, the document including data identifying a sequence of reports of the report navigation workflow and data identifying parameters passed to generate each report in the report navigation workflow.
